(19) United States
(12) Patent Application Publication
(10) Pub. No.: US 2005/0014086 A1
(43) Pub. Date: Jan. 20, 2005

(54) "High ortho" novolak copolymers and composition thereof

(76) Inventors: Sambasivan Venkat Eswaran, Delhi (IN); Pradeep Kumar Basu, Delhi (IN); Debmalya Roy, Delhi (IN)

Correspondence Address: VENABLE, BAETJER, HOWARD AND CIVILETTI, LLP, P.O. BOX 34385, WASHINGTON, DC, 20043-9998, US

(21) Appl. No.: 10/481,461

(22) PCT Filed: Apr. 19, 2002
(86) PCT No.: PCT/IN02/00109

(30) Foreign Application Priority Data
Jun. 20, 2001 (IN) 687/DEL/01

(51) Int. Cl. G03C 1/76; C08G 8/04

(52) U.S. Cl. 430/270.1; 528/153

(57) ABSTRACT

A two step process for preparation of “high ortho” novolac resins. A first step involving reaction of phenolic component with formaldehyde carried out at room temperature, which ensures that all the formaldehyde used in the reaction is in liquid state, which almost completely reacts with phenolic compound, leaving no unreacted formaldehyde as effluents. The process uses CNSL or CNSL based phosphorylated prepolymer, or CNSL based monomeric Cardanol or hydrogenated Cardanol or vicinally hydroxylated Cardanol with formaldehyde and other phenolic compounds like m-cresol or p-cresol or o-cresol or 3.5-dimethylphenol or p-chlorophenol or resorcinol or t-butylphenol the positive and negative photoresists are made by mixing these polymers with appropriate photoactive components. For preparation of e-beam photoresist, these novolac resins are fist derivatised by t-BOC and then mixed with photoacid generator.

### FIELD OF INVENTION

This invention relates to a process for preparation of cashew nut shell liquid (CNSL) based “high ortho” novolac copolymers specifically, but without implying any limitation thereof, for application as photoresist for microlithography besides other potential uses after curing, such as breaklinings, surface coating, foundry core oil, laminating and rubber compounding resins and adhesives, as composites and flame-retardants.

### PRIOR ART

Microlithography is the technique which deals with the fabrication of Integrated Circuits (IC's) as micron or sub-micron level which enables Very Large Scale Integration (VLSI) required for construction of the most modern electronic gadget. In microlithography, a photoresist composition, comprising of a photoactive component (PAC), matrix polymer (novalac resin) and additives dissolved in an organic solvent, is applied to the surface of a substrate such as silicon wafers used for making integrated circuits (IC's), or aluminium or copper plates of printed circuit boards (PCB). The substrate with coated surface is baked to remove solvent and to fix the coating on to the surface of the substrate and thereafter the baked surface is exposed to radiation like ultra-violet (UV) light, electron beam, X-ray radiant energy, etc. The surface of the substrate, is then treated with a developer solution which is selected to either dissolve and remove the radiation exposed part of the coated substrate or the unexposed areas of the coated surface of the substrate.

Novolac resins are formed by the acid or metal ion catalyzed co-condensation of phenols with formaldehyde. However for better lithographic performance, phenol-formaldehyde based novolacs have been replaced by cresol-formaldehyde based novolac resins. For photoresist applications, acid catalyst is preferred to avoid metal contamination in semiconductor manufacturing. Earlier, the novolacs used were “random novolacs”, having structure as shown in FIG. 1. These “random novolac” resins are characterized by very high polydispersivity value which is defined as the ratio of M_{w} (weight average molecular weight) to Mₙ (number average molecular weight). Whereas the “high ortho” novolacs have linear chains consisting of high percentages of “ortho-ortho methylene bridging” as shown in FIG. 1. Recently, “high ortho” novolacs are being preferred particularly for photoresist applications because of the sharp difference in solubility between radiation-exposed and radiation-unexposed parts of the coated surface of the substrate in developer solution.

The photoresists are broadly categorized as positive photoresist and negative photoresists. In positive photoresists, the radiation-exposed parts of the coated substrate get dissolved during treatment with the developer solution while in the case of negative photoresists, the radiation-unexposed parts of the coated substrate, get dissolved during treatment with developer solution. It has been found that the alternating novolacs made by m-cresol and p-cresol and having —CH₃ radical in the chain alternately at meta and para position are good for negative photoresists whereas the semi-alternating novolacs made by m-cresol and p-cresol having —CH₃ radical in sequence of meta-meta-para position, as shown in FIG. 1, are good positive photoresists.

According to one of the process known in the art as per U.S. Pat. No. 4,148,65, novolac resin is prepared by a one-step process involving heating with stirring of a mixture of two phenol compounds, acid, and formaldehyde to a temperature of 100° C. for 8 hours followed by heating to 180 to 190° C., under reduced pressure to eliminate unreacted formaldehyde. To this novolac resin, photoactive compound is added. The two phenol compounds are taken in the ratio of 90:10 to 30:70, formaldehyde in the range of 50 to 90% by mole, and aromatic azido compound as photoactive compound, is added in the range 5 to 40% based on the weight of polymer. One phenol compound is taken from phenol or cresol and at least one other phenol compound is selected from the compounds like phenylphenol, cyclohexyphenol, isopropylphenol, p-tert-octylphenol, etc. (i.e. compounds having alkyl radical with 3 to 25 carbon atoms, a phenyl radical or cyclohexyl radical) or from compounds like 2,4-xylenol, 3,4-xylenol, etc.

A disadvantage of the above process is that formaldehyde is not fully used up and the effluent may contain unreacted formaldehyde which causes environmental pollution.

Another disadvantage of the above process is that the novolac resins are so rapidly formed that the resultant polymer cannot be tailor-made to desired composition.

Still another disadvantage of the above process is that the process does not leat to “ortho” novolac which is necessary for high performance photoresists.

Another process known in the art (Australian Patent AU 47455/93), a negative photoresist composition is based on aryl azides and purified novolac resin which is purified by heating in an alkaline medium at a temperature of 70 to 85 degree Celsius.

A disadvantage of the above process is that novolacs obtained are “random novolacs” with structure as shown in FIG. 1, and do not have any “high ortho” structure.

Another disadvantage of the composition is that the photoresist composition obtained by the above process leads to formation of striations after exposure and development which restricts its successful use in microlithography.

According to another process known in the art as per U.S. Pat. No. 5,324,620, novolacs are made with four phenolic derivatives and formaldehyde in the mole ratio of 1:1.01, using acid catalyst.

A disadvantage of this process is that it leads to “random novolacs”.

Another disadvantage of this process is that growth of the novolac copolymers, can not be tailor-made.

According to still another process known in the art, as per U.S. Pat. No. 5,237,037, the fully substituted novolac resins made by the acid condensation reaction between phenolic monomers, phenolic dimmers and aldehyde source.

A disadvantage of the above process is that novolac obtained is not “high ortho” novolac.

Another disadvantage of the above process is that the different monomers are linked randomly because there is no way to control the process.

### OBJECTS OF PRESENT INVENTION

The primary object of the present invention is to propose a process for preparation of “high ortho” novolac resin which in combination with photoactive component, is suitable specificatlly as photoresist in microlithography besides other potential uses after curing for applications such as break-lining, surface coating, flame-retardant, laminating and rubber compounding resin and adhesives.

Another object of the present invention is to propose a process for preparation of “high ortho” novolac resins which is a two step process that fully uses up the formaldehyde taken in the reaction and thus leaves no unreacted formaldehyde thereby avoiding discharge of effluents containing unreacted formaldehyde and thus making the process environment-friendly.

Still another object at the present invention is to propose a process for preparation of “high ortho” novolac resins based on cashew nut shell liquid (CNSL) or CNSL based phosphorylated prepolymer or CNSL based monomeric Cardanol or hydrogenated Cardanol or vicinally hydroxylted Cardonol.

Further object of present invention is to propose a process for preparation of “high ortho” novolac resin which enables preparation of positive photoresist, negative photoresist and e-beam resist depending upon the requirement. For preparation of negative photoresist, the photoactive component taken is aromatic azide whereas for preparation of positive photoresist, the photoactive component (PAC) is 1,2-Diazonaphthoquinone-5-sulfonic acid (DNQ) esterified with 2,3,4-trihydroxybenzophenone. In case of e-beam resist, these novolacs are first derivatised to a t-BOC (tertiarybutoxycarbonyloxy) derivative and then mixed with photoacid generator (PAG).

Yet further object of the present invention is to propose a two-step process where-in by introducing curing in second step of the process, by heating in HMTA (Hexamethylene tetrammine) at about 120° C. for about one hour, novolacs with potential uses like break lining, surface coating, flame retardant, laminating and rubber compounding resin and adhesives, can be prepared.

Still further object of the present invention is to propose a process for preparation of “high ortho” novolac resins which enables tailored growth of polymer chain by appropriate choosing of cresylic component.

Even further object of the present invention is to propose a process which provides “high ortho” novolac resins with lowpolydispersivity value.

### DESCRIPTION OF THE INVENTION

According to this invention, there is provided a process for preparation of “high ortho” novolac resins comprising in a first step of preparation of bis-hydroxymethylated phenolic prepolymer by reacting a first phenolic component with formaldehyde in presence of alkali, followed by mixing with a second phenolic component, acidifying and washing with water containing 1% oxalic acid, and in a second step of condensation polymerization of prepolymer obtained by said first step with further quantity of said second phenolic component taken in quantity 90-100% by weight of said first phenolic component, followed by steam distillation, fractionation, crystallization, treating with photoactive active component in the presence of a solvent for application as photoresist and curing for applications of novolac other than photoresist with Hexamethylene Tetraamine (HMTA) in the presence of nitrogen at elevated temperatures.

In the first step of the process, the prepolymer of one phenolic compound is made at room temperature with continuous stirring for 48 hours, by mixing phenolic component with formaldehyde, in the presence of a base. The second step of the process involves polymerization of the prepolymer obtained by first step with the desired second phenolic component, at 140-150° C. for 45 minutes using oxalic acid as catalyst, xylene as solvent and Dean Stark trap apparatus to remove water formed during polymerization and hasten the polymerization process. The mixture is subjected to steam distillation to remove unreacted phenol & solvent and then the residue is subjected to fractionation by repeated treatment with methanolic NaOH, decantation and acidification with ice cold diluted HCl to get the final desired base soluble novolac resin. These resins are then mixed with the photoactive compound and dissolved in appropriate solvent to make the desired composition for photoresist. These are mixed with aromatic azide for negative photoresist, DNQ for positive photoresist and derivatised by t-BOC for e-beam resist. These novolacs are cured with Hexa methylene tetrammine (HMTA), for other potential applications, like break-linings, surface coating, flame-retardant, laminating and rubber compounding resin and adhesives.

### DESCRIPTION OF FIGURES

FIG. 1:—shows the structure random novolac, “high ortho” novolacs, alternating novolac and semi-alternating novolac.

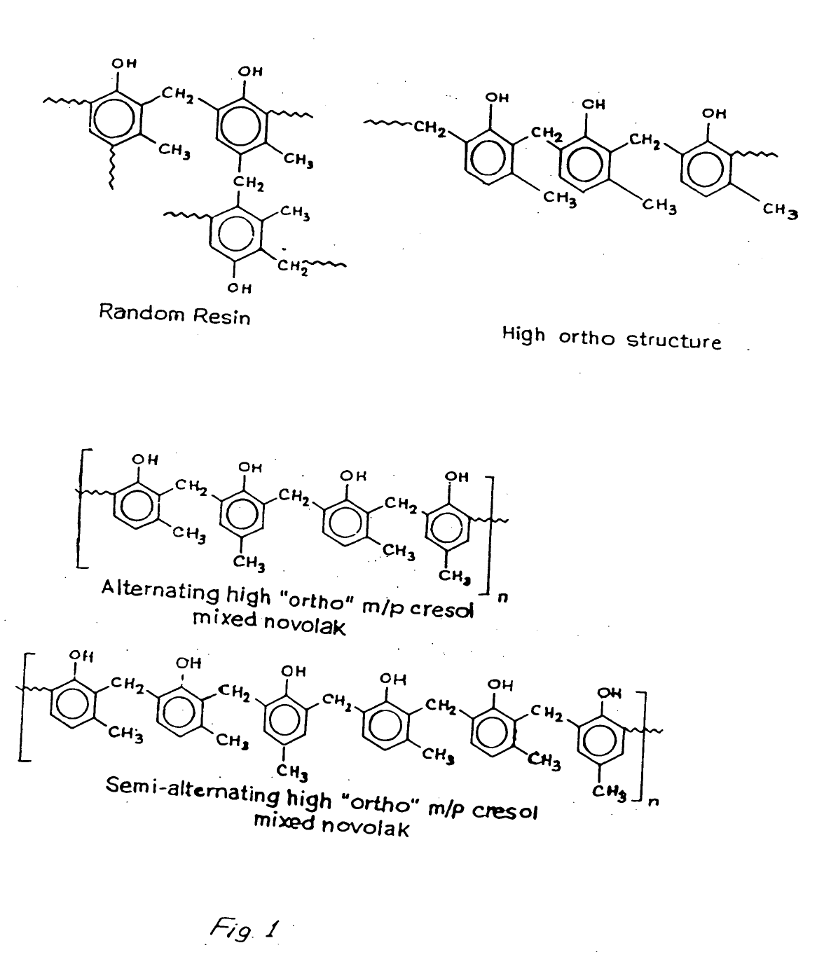

FIG. 2:—FT-IR spectrum at m-cresol and Cardanol based alternating “high ortho” novolac.

FIG. 3:—¹H-NMR spectrum of m-cresol and Cardanol based alternating “high ortho” novolac.

FIG. 4:—¹³C-NMR spectrum of m-cresol and Cardanol based alternating “high ortho” novolac.

### DETAILED DESCRIPTION OF THE PROCESS

The process of the present invention comprises of following steps:

### Step-1: Preparation of bis-hydroxymethylated prepolymer

One phenolic component is mixed with formaldehyde in the presence of base at room temperature and mechanically stirred for 48 hours to prepare the bis-hydroxymethylated prepolymer. The phenolic component is like m-cresol, p-cresol o-cresol, 3,5-dimethylphenol, p-chlorophenol, resorcinol, t-butyl phenol, CNSL, CNSL based phosphorylated prepolymer, CNSL based monomeric Cardanol, hydrogenated Cardanol, vicinally hydroxylated Cardanol, preferably CNSL or CNSL based monomeric Cardanol. The formaldehyde and phenolic components are taken in the molar ratio range of 2:1 to 2.5:1 preferably in the solar ratio range of 2.2:1 to 2.25:1. The base used is like NaOH, KOH or preferably Tetra methyl ammonium hydroxide (TMAH) to reduce metal contamination which is taken with phenolic resin in the molar ratio range of 0.8:1 to 1.2:1, preferably in equal molar quantity to that of phenolic resin. This prepolymer is mixed with second phenolic component with equal molar ratio of first phenolic component, which will be used in second step and the acidified to pH 3-4 with sulphuric acid or hydrochloric acid. The liquid bis-hydroxymethylated prepolymer is washed with water containing 1% oxalic acid.

### Step-2: Polymerization and Purification

The bis-hydroxymethylated phenolic pre-polymer obtained by step-1, is mixed with further quantity of second phenolic component which is taken in quantity 90-100% by weight of the first phenolic component taken in step-1. To this mixture, solvent xylene and solid oxalic acid as catalyst are added, xylene is taken in quantity 80% v/w of the total phenolic components, preferably equal in volume with the total amount of phenolic compounds, while the solid oxalic acid (as catalyst) is taken in quantity of 1% by weight of total phenoli components and prepolymers. For preparation of alternating novolac useful for negative photoresists, the first component taken in step-1 is m-cresol, then second phenolic component taken in this step is Cardanol; if phenolic component taken in step-1 is Cardanol, second component taken in step is p-cresol; whereas if first phenolic component taken in step-1 is p-cresol then second phenolic component taken in this second step is Cardanol. For preparation of semi-alternating novolac for application as positive photoresist, if first phenolic component is step-1 is m-cresol, then phenolic component taken in the second step is a mixture of Cardanol & p-cresol, preferably in equal quantity. However, if the phenolic component taken in first step is Cardanol, then phenolic components taken in the second step is a mixture of m-cresol and p-cresol, in the equal molar amount.

The mixture is then heated at 140-150° C. in an oil bath with a Dean Stark Trap apparatus for 45-50 minutes to remove water formed during polymerization. The mixture is then subjected to steam distillation at about 160-180° C., preferably at 170-180° C. to remove unreacted phenolic components and solvent. The crude novolac is then subjected to fractionation. For this purpose, the crude novolac is treated with methanolic NaOH solution and diluted with water to 40-60%, preferably 50%. The insoluble fraction is separated from solution fraction by decantation. The filtrate is then acidified with ice cold dilute HCl. The polymer obtained is re-dissolved again in aqueous alkali and again acidified with ice cold dilute HCl and this is repeated number of times. The purified fractionated polymer thus obtained is then subjected to crystallization by dissolving in benzene and then reprecipitating by adding n-hexane, so as to remove inorganic impurities.

These recrystallized novolacs are then mixed with photoactive component (PAC) which is either aromatic azide (for preparation of negative photoresist) or with 1,2-Diazonaphthoquinone-5-sulfonic acid esterified with 2,3,4-trihydroxy benzophenone (for preparation of positive photoresist) and dissolved in solvent like ethyl cellosolve acetate or preferably environment-friendly ethyl lactate. The weight proportion of PAC (Azide or DNQ), photoresist, the novolacs are first derivatised by t-BOC and then mixed with photoacid generator (PAG). The solution is filtered through 0.5 micron filter and preserved in cool, dark and dust free conditions.

These recrystallized novolac resins are subjected to curing with HMTA at 110-140° C. preferably 120-125° C. in an oven in presence of nitrogen for applications other than photoresist. The HMTA is taken in quantity 3-4 times than that of novolac.

The invention is now illustrated with working examples which are indicative examples to illustrate the working of the invention and are not intended to be taken restrictively to imply any limitation on the scope of the invention.

### WORKING EXAMPLES

Example on Preparation of Alternating Novolac Resin

CNSL based monomeric Cardanol (1 mole) was mixed with HCHO (2.2 moles) in the presence of NaOH (1 mole) at room temperature with stirring. After 48 hours the prepolymer was formed which was mixed with one more of m-cresol and acidified to 3-4 pH using H₂SO₄. The organic layer was then taken out and washed with comparable volume of water containing 1% oxalic acid. One mole of m-cresol was the added and condensation was carried out at 145° C. in presence of oxalic acid as catalyst and xylene as solvent. After 40-45 minutes the heating was stopped and subjected to steam distillation at a temperature 175° C. The polymer was then fractionated by methanolic NaOH and water. The aqueous part was acidified with ice-cold HCl and again dissolved in aqueous NaOH and reprecipitated by ice-cold HCl. The final polymer was recrystallized using benzene and n-hexane.

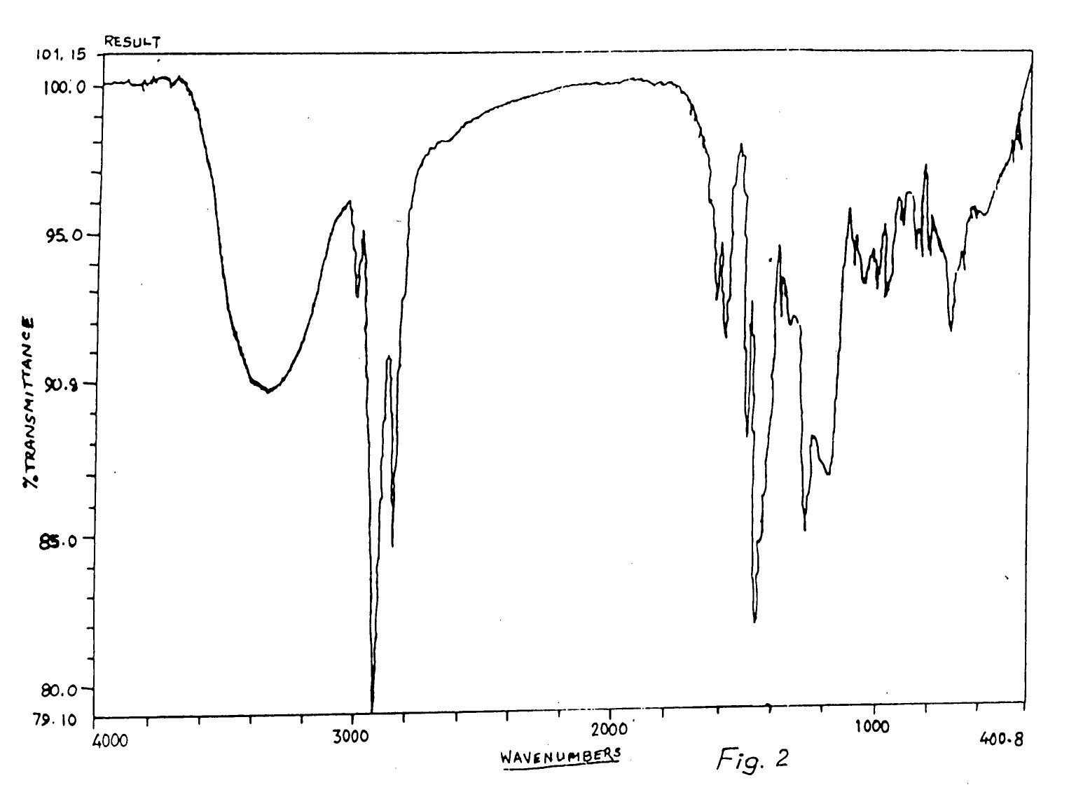

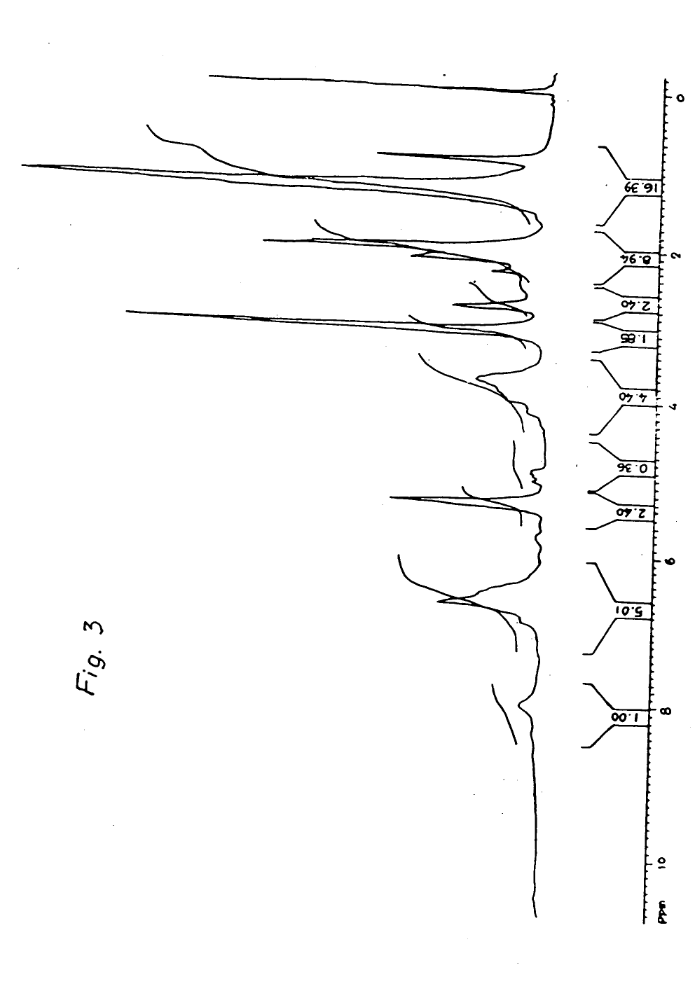

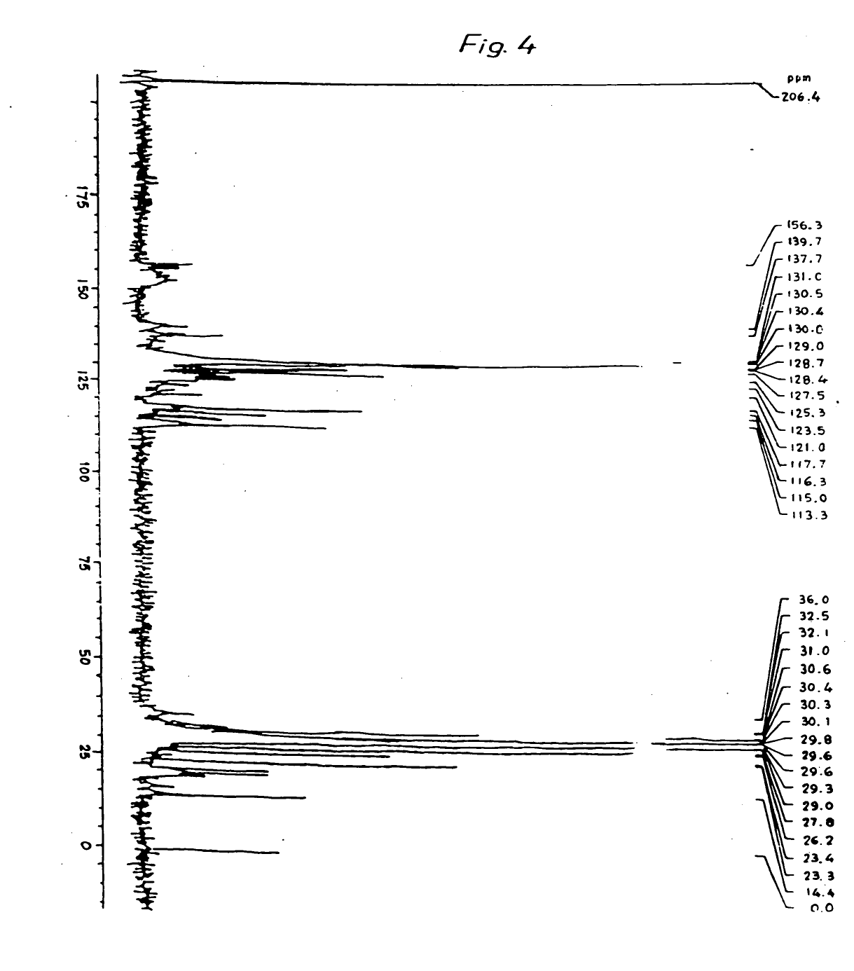

The novolac obtained was fully characterized by ¹H-NMR. ¹³C-NMR, DEPT, Gel Permission Chromatography (GPC). High Performance Liquid Chromatography (HPLC), FT-IR, UV & glass transition temperature (T₉) determination by Differential Scanning Calorometry (DSC). The sharp NMR signals and very low polydispersivity (PD) value, as low as 2.66, shows that the ovolac is “high ortho” and linear in nature. The signals at δ=5.2-5.5 ppm (for double bonds in Cardanol), δ=0.85 ppm (for Aliphatic —CH₃ in Cardanol) in ¹H-NMR spectroscopy (see FIG. 3) and signals in =14.4 ppm (for Aliphatic —CH₃ in Cardanol) in ¹³C-NMR spectra (see FIG. 4) clearly prove that the Cardanol unit is incorporated in the polymer. The signal at δ=8.1 ppm in ¹H-NMR spectra and 3352 & 3009 cm⁻¹ in FT-IR spectra (see FIG. 2) (for phenolic —OH group), aromatic methyl signal at δ=2.1 ppm in ¹H-NMR spectra & the signal at 2924 cm⁻¹ in FT-IR spectra shows that m-cresol unit is also incorporated in the polymer. The sharp signal at δ=3.5 ppm in ¹H-NMR spectra and δ=26.2-33.3 ppm in ¹³C-NMR spectra confirms that the methylene bonding is largely ortho-ortho.

The negative photoresist was made by dissolving this recrystallized novolac and aromatic azide in solvent like ethyl cellosolve acetate or environment-friendly ethyl lactate. The weight proportions azide, novolac and solvent were about 1:5-6:10-12. The solution was filtered through 0.5 micron filter and preserved in cold, dark and dust free conditions.

### Example on Preparation of Semi-Alternating Novolac Resin

In the first step of the process, bis-hydroxymethylated p-cresol was made by stirring the mixture of p-cresol, formaldehyde and NaOH at room temperature for 48 hours in the molar ratio 1:2.2:1. The mixture was made into liquid form by adding 1 more of m-cresol in the mixture and acidifying it with ice-cold dilute HCl. The liquid bis-hydroxymethylated p-cresol thus obtained, was washed with water containing 1% Oxalic acid. Simultaneously, liquid bis-hydroxymethylated Cardanol was also separately made by adding 1 mole of m-cresol in the mixture of Cardanol, formaldehyde and NaOH in the molar ratio 1:2.2:1which was stirred for 48 hours and acidified with ice-cold HCl. The liquid bis-hydroxymethylated Cardanol was washed with water containing 1% Oxalic acid.

In the second step, liquid bis-hydroxymethylated p-cresol and liquid bis-hydroxymethylated Cardanol obtained by step-1, were mixed with 1 mole of m-cresol and condensation was carried out at 145° C. in presence of oxalic acid and xylene for 50 min. The mixture was subjected to steam distillation at a temperature 175° C. The novolac was then fractionated by methanolic NaOH and water. The NaOH soluble fraction was then recrystallized by ethyl acetate and n-hexane.

The positive photoresist was made by dissolving this recrystallized novolac and 1,2-Diazonaphthoquinone esterified with 2,3,4 trihydroxy benzophenone in solvent like ethyl cellosolve acetate or more environment-friendly ethyl lactate. The weight proportions DNQ, novolac and solvent were as 1:5-6:10-12. The solution was filtered through 0.5 micron filter and preserved in cold, dark and dust free conditions.

Example on preparation of CNSL and meta-cresol based novolac m-Cresol (1 mole) was mixed with HCHO (2.2 moles) in the presence of NaOH (1 mole) at room temperature with stirring. After 48 hours, bis-hydroxymethylated prepolymer was mixed with one mole of phosphorylated prepolymer of CNSL and acidified to 3-4 pH using H₂SO₄. The organic layer was then taken out and washed with comparable volume of water containing 1% oxalic acid, one mole of phosphorylated prepolymer of CNSL was then added and condensation was carried out at 140° C. in presence of oxalic acid as catalyst and xylene as solvent. After 40-45 minutes, heating was stopped and polymer formed on cooling. It was then subjected to steam distillation and fractionation. The final polymer is recrystallized from ethyl acetate and n-hexane.

It is to be understood that the process of the present invention is susceptible to adaptations, changes, modifications by those skilled in the art. Such adaptations, changes, modifications are within the scope of the present invention, which is further set forth under the following claims.

1. A process for the preparation for high ortho novolac resins including alternating and semi alternating high ortho novolac resins comprising in a first step of preparation of bishydroxymethylated phenolic prepolymer by reacting a first phenoli component with formaldehyde in the presence of alkali followed by mixing with a second phenolic component, acidifying and washing with water containing 1% oxalic acid, and the second step of condensation polymerization of prepolymers obtained by the said first step with further quantity of the said second phenolic component followed by steam distillation, fractionation, crystallization;
Wherein either of the said first phenolic component or the said second phenolic component comprises at least one cashew nut shell liquid (CNSL) based natural phenolic.

2. A process as claimed in claim 1 wherein the said acidified prepolymer solution at the end of first step has about 3-4 pH value.

3. A process as claimed in claim 1 wherein the said formaldehyde and the said first phenolic component are taken in the molar ratio range from 2.1 to 2.5:1 preferably, in the molar ratio range of 2.21:1 to 2.25:1.

4. A process as claimed in claim 1 wherein the said alkali of said first stop is preferably tetramethyl ammonium hydroxide.

5. A process as claimed in claim 1 wherein the molar ratio of the said alkali to the said first phenolic component is 0.8:1 to 1.2:1 preferably 1:1.

6. A process as claimed in claim 1 wherein the said second phenolic component is taken 90 to 100% by weight of the said first phenolic component in the said first step.

7. A process as claimed in claim 1 wherein the said condensation polymerization is carried out in the presence of a solvent being xylene taken in an amount of 80%-100% by weight of the total phenolic components.

8. A process as claimed in claim 1 wherein the condensation polymerization is carried out in the presence of a catalyst solid oxalic acid taken in the quantity 1% of the weight of second phenolic component and prepolymer obtained in first step.

9. A process as claimed in claim 1 wherein the said condensation polymerization in the said second step is carried out preferably at 140-150° C.

10. A process as claimed in claim 1 wherein the said steam distillation In the said second step is carried out at 160-180° C. preferably at 170-180° C.

11. A process as claimed in claim 1 wherein the said fractionation is carried out in repeated cycles comprising the steps of treating crude novolac with methanolic NaOH and then diluted to 40-60%, preferably 50% by volume with water, filtration and re-procipitating by acidifying the filtrate with ice cold dilute HCl.

12. A process as claimed in claim 1 wherein the said crystallization is carried out by using benzene or ethyl acetate and n-hexane as organic solvents.

13. A process as claimed in claim 1 wherein for preparation of alternating high ortho novolac resins, the preferred combinations of the said first phenolic component and the said second phenolic component are as under,

| First Phenolic component | Second Phenolic Component |
|---|---|
| m-cresol | Cardanol |
| p-cresol | Cardanol |
| Cardanol | m-cresol |

14. A process for the preparation of photoresist from the said high ortho novolac resin prepared from the process as claimed in claim 1 by treating the said high ortho novolac resin with a photoactive component in the presence of a solvent.

15. A process as claimed in claim 14, wherein aromatic azide is used as the said photoactive component for the preparation of negative photoresist.

16. A process as claimed in claim 14, wherein 1,2-Diazonaphthoquinone-5-sulfonic acid esterified with 2,3,4-trihydroxy benzophenone, is used as photoactive component, for the preparation of positive photoresist.

17. A process as claimed in claim 14, wherein for making e-beam photoresist, the said high ortho novolac resins are first derivatised by t-BOC (tertiary butoxycarbonyloxy) derivative and then mixed with the photoacid generator (PAG).

18. A process for the preparation of photoresist as claimed in claim 14, wherein the said solvent is ethyl cellosolve acetate or preferably ethyl lactate.

19. A process for the preparation of photoresist as claimed in claim 14, wherein the said photoactive component, the said high ortho novolac resins and the said solvent are taken preferably in the ratio of 1:5-6:10-12 by weight.

20. A process for the preparation of cured novolac resin from the said high ortho novolac resin prepared from the process as claimed in claim 1 by treating the said high ortho novolac resin with HMTA (Hexamethylene tetrammine) at 110-140° C., preferably at 120-125° C. in presence of nitrogen atmosphere.

21. A process for the preparation of cured novolac resin as claimed in claim 20 wherein the said HMTA is taken preferably 3-4 times by weight of the quantity of the said high ortho novolac resin.

22. High ortho novolac resins including alternating and semi alternating high ortho novolac resins prepared substantially from the preceding claims.

23. Photoresists prepared substantially from the preceding steps.

24. Cured novolac resins prepared substantially from the preceding steps.
